(19) United States
(12) Patent Application Publication
(10) Pub. No.: US 2008/0216326 A1
(43) Pub. Date: Sep. 11, 2008

(54) Multipurpose hand tool with rotatable handle

(75) Inventors: Glenn A. Klecker, Silverton, OR (US); Hollan A. Tsuda, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Leatherman Tool Group, Inc.

(21) Appl. No.: 11/716,142

(22) Filed: Mar. 9, 2007

(51) Int. Cl. B26B 1/04

(52) U.S. Cl. 30/161

(57) ABSTRACT

A multipurpose tool including a tool such as pruning shear in which one handle includes a storage cavity to hold folding tool elements. That handle is rotatable about a longitudinal axis, between a position in which it presents comfortable outer surfaces to be gripped during use of the pruning shear, and a position exposing the folding tool elements to be extended. A blade latch release lever for releasing the folding tool elements may include grip ears located at the sides of the main handle.

### BACKGROUND OF THE INVENTION

This invention relates to multipurpose hand tools and particularly to a tool whose handle provides a comfortable grip during use and also provides storage for folding tool blades or tool bits.

Multipurpose hand tools often provide for storage of folding blades within a cavity defined within a handle. For a two-handled hand tool such as pliers or shears, orientation of the handles so as to present a comfortable outer face to be gripped when the handles are squeezed toward each other has required the handles of many such tools to be spread apart from each other in order for folding blades to be moved between their folded and their extended positions. Where a two-handled tool includes one or more sharp-edged blades, as in a pruning shear, swinging the handles apart from each other may expose a sharp edge of a working portion of the tool where it may be damaged or may cause injury to an inattentive user of the tool.

Where folded blades are exposed between a pair of handles of a scissors-action tool there is a risk of injury if a folded knife blade should move out of a storage cavity and leave a space where a user's finger could encounter a sharp edge, as in some previously known hand tools.

What is desired, then, is a multipurpose hand tool including a handle capable of being gripped comfortably during use of the tool and which can nevertheless safely and readily provide access to folded tool blades and bits without exposing sharp-edged blades of the tool unnecessarily.

### SUMMARY OF THE DISCLOSURE

The present application discloses a hand tool which provides an answer to the aforementioned shortcomings of previously known tools, as defined by the claims which form a part of the disclosure herein.

In a pruning shear which embodies one aspect of the present invention, a pair of handles are arranged to be gripped comfortably by one hand to operate the pruning shear. One handle of the pair includes a storage cavity to hold one or more folding blades or tool bits attached pivotably to an outer end of that handle, and that handle is mounted so as to be able to pivot around a longitudinal axis to present the folded blades or tool bits where they are available to be extended without moving the handles apart from each other, so that the blades of the pruning shear can remain latched closed while knife blades are folded into or extended from the handle.

As one aspect of the hand tool disclosed herein, a rotary coupling is provided in which a conveniently operable lock normally holds a handle securely in a selected position of rotation about an axis.

As one aspect of the hand tool disclosed herein, a latch mechanism for holding a selected one of the folding blades or tool bits in an extended position relative to the handle includes latch release grips available conveniently at the sides of the handle.

As one aspect of the tool disclosed herein a guard extends from a central body portion of the tool and along a portion of the handle, preventing a folded blade from being unfolded from storage in the handles during use of the pruning shears.

The foregoing and other features and advantages of various aspects of the invention will be more readily understood upon consideration of the following detailed description taken in conjunction with the accompanying drawings.

### BRIEF DESCRIPTION OF THE SEVERAL DRAWINGS

FIG. 1 is a right side elevational view of a multipurpose hand tool including a bypass pruner and embodying the present invention, with the pruner latched in a closed position and with a top, or rear, handle in a position providing for a comfortable grip during use of the pruner.

FIG. 2 is a right side elevational view of a portion of the hand tool shown in FIG. 1, with the pruner unlatched and the handles and pruner blades opened.

FIG. 3 is a left side elevational view of the hand tool shown in FIGS. I and 2, with the handles and blades latched in a closed position as in FIG. 1.

FIG. 4 is a top plan view of the hand tool shown in FIG. 3.

FIG. 5 is a top plan view of a portion of the hand tool shown in FIG. 3, with the top, or rear, handle rotated with respect to the rest of the tool to a position opposite that shown in FIGS. 3 and 4.

FIG. 6 is a left side elevational view of the portion of a tool shown in FIG. 5, with the top or rear handle in the position shown in FIG. 5.

FIG. 7 is a sectional view of a portion of the hand tool, taken along line 7-7 of FIG. 4, at an enlarged scale.

FIG. 8 is a sectional view of a portion of the hand tool, taken in the direction of the line 7-7 in FIG. 4, showing the top, or rear, handle rotated to the position in which it is shown in FIGS. 5 and 6, and showing a portion of a knife blade that is latched in an extended position with respect to the handle.

FIG. 9 is a sectional view taken along line 9-9 of FIG. 7, showing the locking mechanism of the rotary coupling between the handle and the main body of the hand tool.

FIG. 10 is a sectional view similar to that in FIG. 9, showing the push-button depressed and the rotary coupling in an unlocked condition.

FIG. 11 is a partially cutaway top plan view of an outer end portion of the top, or rear, handle of the tool, at an enlarged scale.

FIG. 12 is a sectional view taken along line 12-12 of FIG. 11.

FIG. 13 is view similar to FIG. 12 showing the latch release lever moved to a blade-releasing position.

### DETAILED DESCRIPTION

Referring now to the drawings which form a part of the disclosure herein, a multipurpose hand tool 20 that includes a pruning shear is shown in FIG. I with the pruning shear in a closed and latched condition and in FIG. 2 with the pruning shear in an unlatched, open condition. The tool 20 includes a first or left side main portion 21 including a first, top, or rear, handle 22, and a second or right side main portion 23 including a more slender second handle 24. The left and right side main portions 21 and 23 are interconnected with each other by a main tool pivot joint having an axis 26. A first working member in the form of a support jaw 28 included in the left side main portion 21 has a base 30, shown best in FIG. 3, that extends from a central body portion 32 to which the first handle 22 is attached.

A second working member in the form of a replaceable sharp-edged by-pass cutter blade 34 has a base 36 mounted detachably, as by rivets 40, on a blade carrier portion 42 of the right side main portion 23. The base of the blade carrier portion 42 extends from a hub portion 44 of the right side main portion 23 that is connected to the central body portion 32 of the left side main portion 21 by the main tool pivot joint. It will be appreciated that the multipurpose tool 20 could instead incorporate other types of working members such as a cutting blade and an anvil of another type of pruner, or various shears or pliers for other purposes.

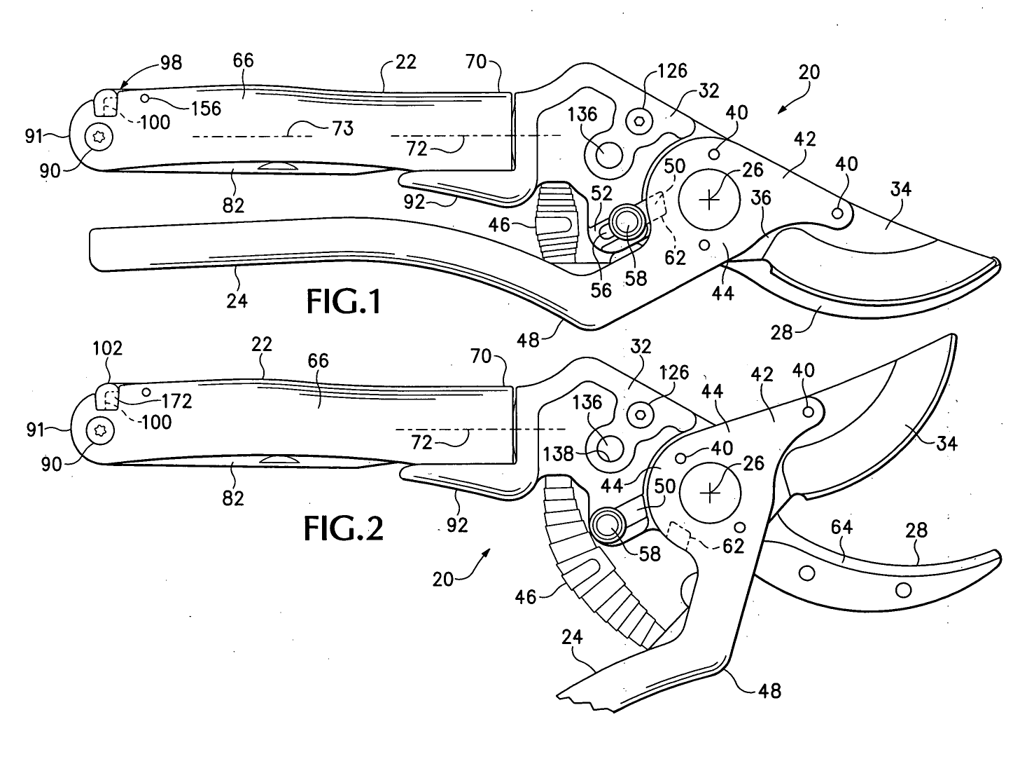

A conventional spring 46 is mounted between the central body portion 32 and a base 48 of the second handle 24 and urges the handles 22 and 24 apart from each other toward the position shown in FIG. 2 in order to open the sharp-edged by-pass blade 34 apart from the support jaw 28. A safety latch to keep the pruning shear safely closed when it is not in use may include a dog 50 located in a channel 52 defined in the central body portion 32 and carried on a cross-pin extending through a slot 56 in the central body portion 32. The dog 50 can be moved along the slot 56 by either of a pair of knobs 58 and 60 located on opposite ends of the cross-pin and on opposite sides of the central body portion 32. Thus the dog 50 can be extended into a receptacle in the form of a pocket 62 defined in the hub portion 44, when the pruning shear is closed with the handles 22 and 24 located close to each other so that the blade 34 is alongside the support jaw 28 as shown in FIG. 1. The safety latch must be released by moving the dog 50 rearwardly in the channel 52 to the position shown in HG. 2, retracting the dog 50 from the pocket 62, in order for the handles 22 and 24 of tool 20 to be separated to the position shown in FIG. 2 by pivoting with respect to each other about the axis 26.

The central body portion 32, the body of the handle 22, and the handle 24 (including its base 48 and hub portion 44) may be made of a light yet suitably strong material such as a die-cast or injection molded aluminum alloy. The bases 36 and 30 may be machined as necessary to receive, respectively, the sharpened blade 34 and a working portion 64 of the support jaw 28, both of which may be made of a more durable and easily sharpened material such as a carbon steel or stainless steel.

In FIGS. 1 through 4 the handle 22 is shown in a normal position with respect to the central body portion 32 to provide a comfortable grip during use of the pruning shear aspect of the multipurpose tool 20. Smooth side faces 66 and a smooth back face 68 of the handle 22 are interconnected with each other along smoothly curved radiused edges, so that the handle 22 in that position presents a comfortable rounded shape with ample surface area to be gripped by a user's hand in operating the pruning shears of the multipurpose hand tool 20.

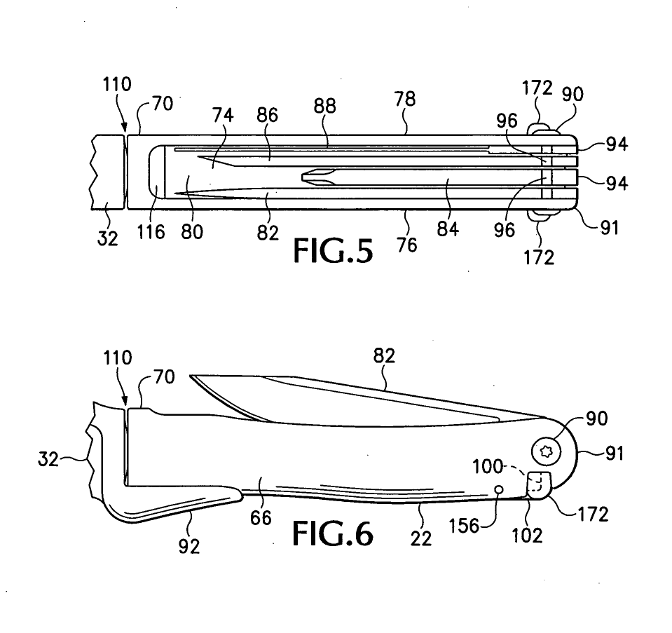

A first, or front end 70 of the handle 22 is joined with the central body portion 32 by a rotary coupling permitting the handle 22 to be rotated about an axis 72 with respect to the central body portion 32 to the position shown in FIGS. 5 and 6. The axis 72 may be more or less parallel with a longitudinal axis 73 of the handle 22.

It may be seen in FIGS. 5 and 6 that the handle 22 has a body defining a storage cavity 74 in a channel defined by a pair of side walls 76 and 78 and a back 80. As shown herein, several folding tool elements, including a knife blade 82, a screwdriver 84, a chisel 86, and a saw 88 may all be stored in a folded position in the cavity 74, with a base portion 94 of each mounted on a tool pivot shaft 90 extending transversely through the handle 22 at its outer end 91. The pivot shaft 90 may be, for example, a tubular screw extending through the side walls 76 and 78 and a base portion of each of the tool blades 82, 84, 86, and 88.

A guard, or keeper 92 protrudes rearwardly from the central body portion 32 at the front end 70 of the handle 22 and extends between the handle 22 and the handle 24, where it prevents the knife blade 82, chisel 86, and saw 88 from being opened from their folded positions within the storage cavity 74 of the handle 22, when the handle 22 is in its normal position of rotation with respect to the central body portion 32, as shown in FIGS. 1-4.

When the handle 22 has been rotated about the axis 72 to the position shown in FIGS. 5 and 6, the guard 92 no longer obstructs any of the folding tool elements, and a selected one, such as the knife blade 82, for example, may be rotated about the tool pivot shaft 90 to an extended position, as shown in FIG. 6.

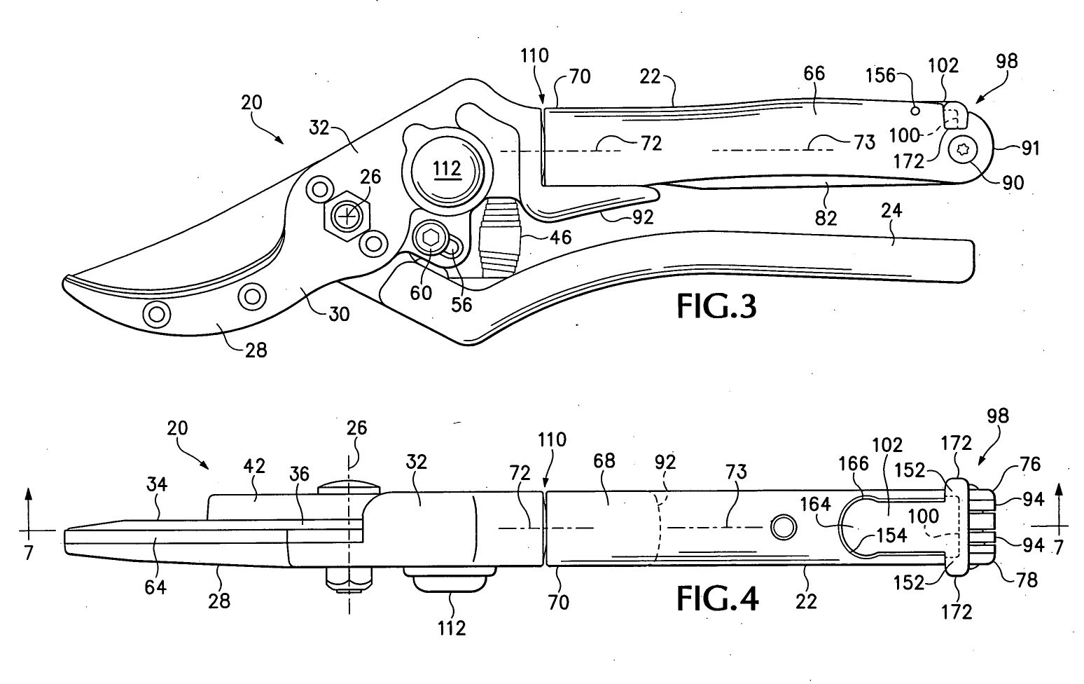

The base portion 94 of each folding tool blade element defines a respective latch engagement notch 96, as may be seen in FIG. 5. A blade locking latch 98 includes a locking bar 100 carried on an outer end of a latch release lever 102, shown in FIG. 4, to engage the latch engagement notch 96 in a selected one of the tool blades 82, 84, 86, and 88, to hold the selected folding tool blade or bit in an extended position, as will be explained in greater detail below.

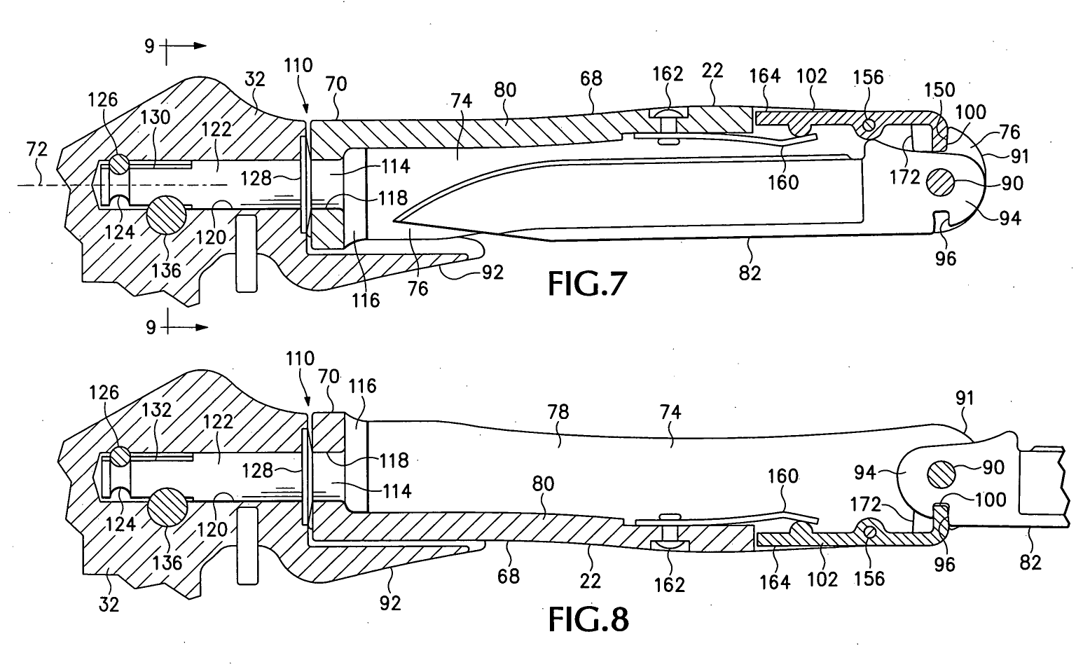

Referring now also to FIGS. 7, 8, 9, and 10, the handle 22 is held securely in a selected position of rotation about the axis 72 with respect to the central body portion 32, either in the position shown in FIGS. 1-4 or the position shown in FIGS. 5 and 6, by a locking rotary coupling 110 that controls rotation of the handle 22 about the axis 72. A push-button 112 is located on the left-hand side of the central body portion 32, as shown in FIGS. 3 and 4, and is used to control operation of the rotary coupling 110. The locking rotary coupling 110 includes a rotating body or spindle 113 including a shaft 114 of suitably strong and durable material such as steel. A mounting base 116 in the form of a head extending radially from a first end of the shaft 114 is shaped, as may be seen in FIGS. 5, 7, and 8, to fit matingly against inner surfaces of the side walls 76 and 78 and back 80 within the storage cavity 74, at the front end 70 of the handle 22, preventing the spindle 113 from rotating with respect to the handle 22. The mounting base could be of another form and could be otherwise connected to the handle 22, so long as a secure, strong, and rigid connection is provided, and the entire spindle member 113 could be formed integrally with the handle 22 using appropriately strong materials.

The shaft 114 extends forward through a shaft receiving bore 118 in the front end 70, and into a corresponding bore 120, defined in the central body portion 22, that acts as a radial bearing to support a journal portion 122 of the shaft 114. It will be understood that a bushing (not shown) of a desired material defining a part of the bore 120 could also be fitted as a bearing within the central body portion 32, if desired, to support the journal portion 122 of the shaft 114. Since the axis of rotation 72 is defined by the shaft 114 the orientation of the shaft receiving bore 118 in the handle 22 establishes the path along which the handle 22 can rotate, and so the bore 118 will usually be generally parallel with a longitudinal axis 73 of the handle 22.

At the distal end 123 of the shaft 114, opposite the mounting base 116 an annular groove 124 is formed around the circumference of the shaft 114, and a retainer screw 126 mated in a threaded bore extending transversely through the central body portion 32 of the tool also passes along and protrudes into the annular groove 124 as shown in FIGS. 7 and 8, keeping the spindle 113 and handle 22 from moving longitudinally away from the central body portion 32. It will be understood that other forms of retainers could also be used to keep the shaft 114 from moving axially from a desired position. For example, a spring clip engaging the annual groove 124 could be held in appropriately located slots (not shown) in the central body portion 32, but the retainer screw 126 provides a secure fastening which is closed against intrusion of dirt.

In order to take up any longitudinal play along the shaft 114 and ensure that the handle 22 feels securely and tightly attached to the central body portion 32, a spring washer 128 may be mounted on the shaft 114 between the handle 22 and the central body portion 32, as shown in FIGS. 7 and 8. The bore 118, together with the side walls 76 and 78 and back 80, holds the mounting base 116 and the shaft 114 securely with a minimum of play, so that the handle 22 will not wobble with respect to the central body portion 32 during use of the pruning shear of the tool 20.

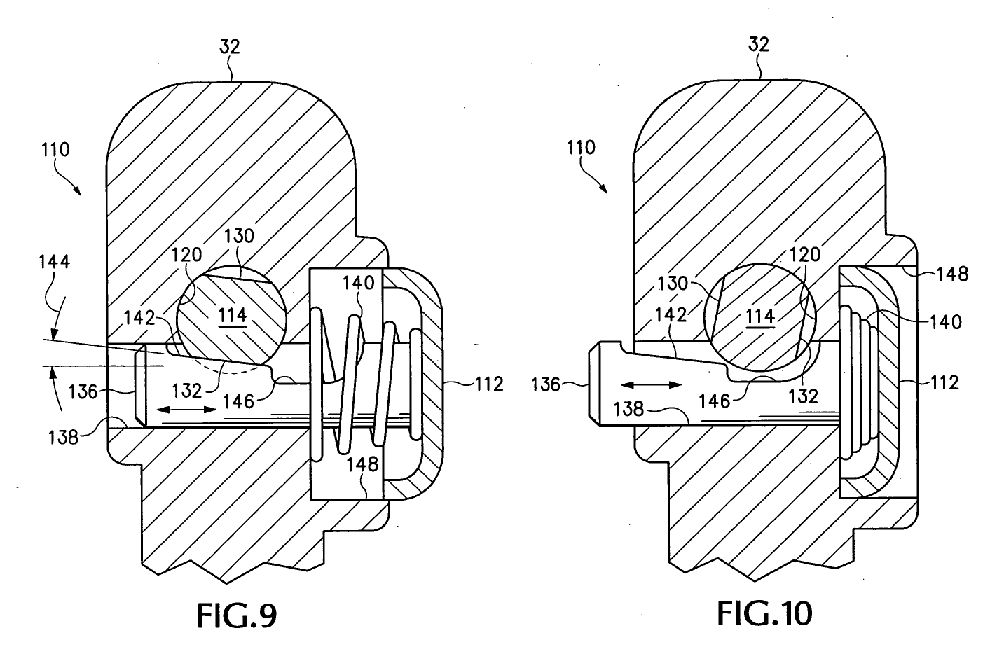

Referring now particularly to FIGS. 9 and 10, a pair of engagement, or locating, faces 130 and 132 are provided on the shaft 114 and may take the form of flats formed on opposite sides of the shaft 114. While the locating faces 130 and 132 are shown in the embodiment of the tool disclosed herein as being flats located near the distal end of the shaft 114, it will be understood that they could instead be located at a different position along the length of the shaft 114, so long as an appropriate location is available for the push-button 112.

Attached to the push-button 112 and extending transversely through the central body portion 32 is a locking body 136 in the form of a transversely extending bolt held slidably in a transverse bore 138 which tangentially intersects the shaft receiving bore 120. A compression spring 140 surrounds the locking body 136 adjacent the inner face of the push-button 112 and urges the locking body 136 toward the left side of the central body portion 32, until a locking ramp or wedge surface 142 comes to bear against one of the locating faces 130 or 132 as shown in FIG. 9 and thereby prevents rotation of the shaft 114 so long as the locking ramp or wedge surface 142 remains engaged with the locating face 130 or 132. The locking ramp surface 142 may be oriented at an angle 144 to a plane parallel with the longitudinal axes of the locking body 136 and the shaft 114, to provide a self-tightening camming action of the locking body 136 with respect to one of the locating faces 130 and 132. An acceptable angle 144 may be within the range of zero to nine degrees, and an angle 144 of about seven degrees has been found to be particularly suitable. The locating faces 130 and 132 are accordingly located at suitable angles with respect to the orientation of the mounting base 116 so that the handle 22 will be held in a desired position of rotation about the axis 72 when the surface of the locking ramp 142 is mated against either of the locating faces 130 and 132.

As shown in FIG. 10, a channel 146 defined in the locking body 136 provides sufficient clearance between the locking ramp 142 and the push-button 112 so that when the push-button 112 is fully depressed into a receptacle 148 defined in the central body portion 32 the shaft 114 and thus the handle 22 can be rotated freely between the positions defined by the locating faces 130 and 132 and shown respectively in FIGS. 3 and 6. Additionally, when the retainer screw 126 is removed and the push-button 112 is fully depressed as shown in FIG. 10 the channel 146 also provides clearance for the shaft 114 to be inserted into or removed from the bore 120 in the central body portion 32 of the tool 20.

When the push-button 112 is depressed fully and the top, or rear handle 22 has been rotated several degrees about the axis 72, the push-button 112 can be released and the handle can continue to be rotated the rest of the way to one of the available positions. The spring 140 will then move the locking body 136 to cause the locking ramp 142 to engage the respective one of the locating faces 130, 132 to securely hold the handle 22 in the selected position of rotation about the axis 72. While the two discrete defined positions established by the locating faces 130, 132 are sufficient for the handle 22 of the tool 20, it is conceivable that 3 or even 4 or more locating faces to establish a like number of discrete positions of rotation of a handle might be desired for a particular hand tool.

### Blade Latch

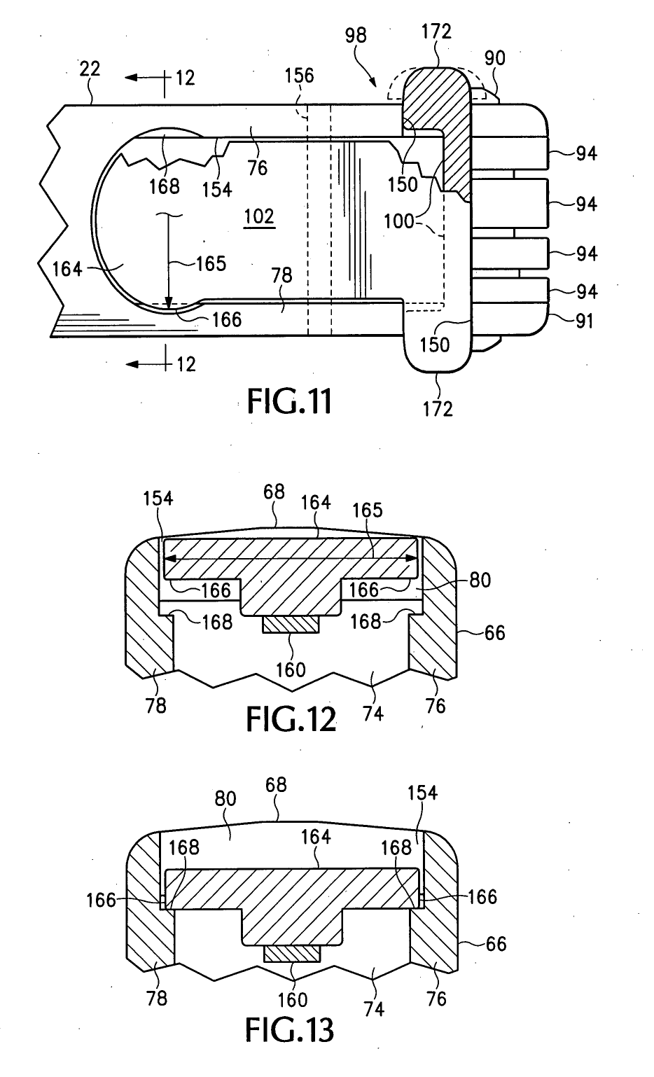

Referring again to FIGS. 5, 6, 7, 8, and also to FIGS. 11, 12, and 13, the latch release lever 102 is mounted in an opening 154 in the back 80 of the handle 22. The locking bar 100 engages not only the latch engagement notch 96 in the base portion 94 of a selected blade such as the knife blade 82 shown extended in FIG. 8, but in the embodiment of the tool 20 as shown the lateral arms 152 of the latch release lever 102 engage each of a pair of latch support notches 150 defined in the side walls 76, 78, as shown best in FIG. 11. While the latch support notches 150 and the corresponding portions of the lateral arms 152 are shown as wider than the locking bar 100 and the latch engagement notches 96, the notches 150 could be of a narrower width, similar to the notches 96, with portions of the lateral arms 152 of a mating size.

The latch release lever 102 is carried on a pivot pin 156 mounted in the side walls 76 and 78 and extending transversely across the handle 22 near its outer end 91. The latch release lever 102 is urged to rotate about the pivot pin 156, in the counter-clockwise direction as shown in FIG. 8, as required for engagement of the arms 152 in the latch support notches 150 and engagement of the locking bar 100 into the latch engagement notch 96 of a selected tool element, by a spring such as the flat spring 160 attached to the back 80 of the handle 22 by a fastener such as a rivet 162, for example, although other serviceable spring arrangements could also be used. A latch release push pad 164 is located at the inner end of the latch release lever 102 opposite the locking bar 100, and may be pushed, against the force of the spring 160, to move the lever 102 about the pivot pin 156. This can disengage the locking bar 100 from the notch 96, so that a folding tool element can be moved about the shaft 91 from its extended position, such as that of the knife blade 82 shown in FIG. 8, toward its folded position within the stowage cavity 74, as shown in FIG. 5, if the back surface 68 of the handle 22 is exposed, as when the handle 22 is in the position shown in FIGS. 1-4, or when the handle 22 is in the position shown in FIG. 6 and the handles 22 and 24 of the tool 20 are spread apart as shown in FIG. 2.

The latch release push pad 164 extends laterally of the handle 22 to a width 165 greater than the distance between the side walls 76 and 78 and includes small side extension parts 166 that extend above ledges 168 located at the bottom of relieved portions in the side walls 76 and 78, adjacent the opening 154, as shown in FIGS. 11, 12, and 13, so that the latch release lever 102 cannot be rotated so far about its pivot pin 156 that it would be likely to damage the spring 160.

When the handle 22 is in the position of rotation shown in FIGS. 5, 6, and 8, and when the handle 24 is in the position shown in FIG. 1, which would normally be the case when a folding tool bit or blade ordinarily stowed in the handle 22 is in use, access to the latch release push pad 164 is somewhat limited by proximity of the handle 24. A pair of grip ears 172 are therefore provided on the latch release lever 102 at the ends of the lateral arms 152. Each grip ear 172 protrudes laterally proud of the adjacent side wall 76 or 78, and thus is accessible to be engaged by a finger or thumb of the user, reaching around the handle 24 and pulling on the grip ears 172 to disengage the locking bar 100 from the latch engagement notch 96 of a tool blade to release it from its extended position and fold it into the stowage cavity 74.

In order to provide for greater comfort, each of the grip ears 172 may be larger than the associated end of the locking bar 100 and lateral arm 152, and the grip ears 172 may thus extend alongside each side face 66 of the handle 22 outside the respective latch support notch 150, as shown in broken line in FIG. 11. The grip ears 172 may thus also extend as gussets between the locking bar 100 and the end of each lateral arm 152.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A subassembly for a hand tool, comprising:
(a) a tool body portion having a working member of said hand tool attached thereto;
(b) an elongate tool handle having an end thereof interconnected with said tool body portion through a rotary coupling having an axis of rotation extending generally longitudinally with respect to said tool handle; and
(c) a releasable locking mechanism associated with said rotary coupling holding said tool handle stationary in a selected one of a plurality of defined positions of rotation about said axis of rotation.

2. The subassembly of claim 1 wherein said rotary coupling has an axis of rotation parallel with a longitudinal axis of said tool handle.

3. The subassembly of claim 1 wherein said rotary coupling includes a shaft and said locking mechanism includes a position controlling portion including a locating face carried on said shaft and locking body arranged to act on said locating face, and wherein said locking body includes a wedge engaged with said locating face when said locking body is in a locking position of engagement with said position controlling portion.

4. The subassembly of claim 3 wherein said locating face is a flat face defined on said shaft.

5. The subassembly of claim 3 wherein said locking body includes a bolt movable tangentially across said position controlling portion and a spring acting between said tool body portion and said bolt and urging said bolt to carry said wedge into engagement with said locating face.

6. A hand tool, comprising:
(a) a first main tool portion including a first working member and a central body portion;
(b) a second main tool portion including a second working member and a hub;
(c) a main pivot joint interconnecting said first and second main tool portions with each other;
(d) a first handle having a front end interconnected with said central body portion;
(e) a second handle extending from said hub of said second main tool portion; and
(f) a rotary coupling interconnecting said first handle with said central body portion, said rotary coupling including locking mechanism holding said first handle in a stationary in a selected one of plurality of discrete defined positions of rotation with respect to said central body portion.

7. The hand tool of claim 6 wherein said rotary coupling has an axis of rotation parallel with a longitudinal axis of said first handle.

8. The hand tool of claim 6 wherein said first handle has a rounded comfortable side that faces outwardly away from said second handle when said first handle is in one of said discrete defined positions of rotation.

9. The hand tool of claim 6 wherein said first and second handles are arranged to be gripped simultaneously by a single hand during use of said first and second working members.

10. The hand tool of claim 6 wherein said first handle defines a blade stowage cavity between a pair of side walls thereof and said tool includes:
(a) a folding tool member attached to a tool pivot at an end of said first handle and having a base located between said side walls and moveable about said tool pivot, between a folded position and an extended position;
(b) a latch release lever attached to said handle by a latch release lever pivot;
(c) a locking bar carried on an outer end of said latch release lever and arranged to engage said folding tool member, thereby holding said folding tool member in a selected position with respect to said second handle; and
(d) a pair of latch release grip ears located on an outer end of said latch release lever, and wherein, when said first handle is located in one of said discrete defined positions of rotation, said folding blades may be opened by swinging in a direction away from said second handle, and said latch release grip ears are exposed and protrude laterally outward beyond a respective one of said side walls of said handle and thus are available to move said latch release lever and thereby release a blade from an extended position thereof.

11. The hand tool of claim 6 wherein said first handle includes a tool storage cavity for folding tool elements in a folded position and wherein when said first handle is in one of said discrete defined positions of rotation the tool storage cavity faces toward said second handle, the hand tool also including a guard extending from said central body portion and longitudinally alongside said first handle in a position preventing a folding tool element from being moved from the folded position when said first handle is in said one of plurality of discrete defined positions of rotation.

12. A rotary coupling joining first and second connected members to each other, comprising:
(a) a spindle member having a mounting base adapted for attachment to a first connected member and including a shaft having a first end interconnected with said mounting base and a second end spaced apart therefrom;
(b) a radial bearing located in a second connected member and supporting said shaft for rotation with respect to said second connected member;
(c) a rotational position controlling portion carried on said shaft; and
(d) a locking body carried in said second connected member and moveable with respect to said second connected member, between a locking position of rotation-preventing engagement with said position controlling portion and a releasing position providing clearance for said shaft to rotate.

13. The rotary coupling of claim 12 wherein said locking body includes a bolt moveable tangentially across said position controlling portion of said shaft into said locking position of engagement.

14. The rotary coupling of claim 13 including a spring acting between said bolt of said locking body and said second connected member and urging said bolt toward said locking position of engagement.

15. The rotary connection of claim 13 including a push-button arranged to move said bolt to said releasing position of said locking body.

16. The rotary coupling of claim 12, wherein said position controlling portion includes a locating face carried on said shaft, and wherein said locking body includes a wedge engaged with said locating face when said locking body is in said locking position of rotation-preventing engagement with said position controlling portion.

17. The rotary coupling of claim 12 wherein said first connected member is a handle of a hand tool and said second connected member is a central body portion of said hand tool.

18. The rotary coupling of claim 12 wherein said position controlling portion includes a flat face defined on said shaft.

19. The rotary coupling of claim 12 including a retainer located at said second end of said shaft and keeping said shaft from moving axially apart from said second connected member.

20. The rotary coupling of claim 19 wherein said retainer includes an annular groove formed at said second end of said shaft and a locking member mounted in said second connected member and extending into mating engagement in said annular groove.

21. A subassembly for a hand tool, comprising:
(a) a tool handle having a pair of side walls and defining a blade stowage cavity between said side walls;
(b) a folding tool element attached to a tool pivot at an end of said handle and having a base located between said side walls and rotatable about said tool pivot, between a folded position and an extended position;
(c) a latch release lever attached to said handle by a latch release lever pivot;
(d) a locking bar carried on an outer end of said latch release lever;
(e) a latch engagement notch defined in said base of said folding tool element and located so as to receive said locking bar when said folding tool element is in a selected position of rotation about said tool pivot; and
(f) a latch release grip ear located on said outer end of said latch release lever and protruding laterally outward beyond a respective one of said side walls of said handle, whereby said locking bar is removable from said latch engagement notch by manually engaging said latch release grip ear and pivoting said latch release lever about said latch release lever pivot.

22. The subassembly of claim 21 wherein said handle includes a pair of latch support notches, a respective one of said latch support notches being defined in each of said side walls of said handle, respective portions of said latch release lever being engaged in said latch support notches and thereby assisting in holding said folding tool element in a selected position with respect to said tool handle.

23. The subassembly of claim 22 wherein said latch release grip ear extends from the locking bar and is located adjacent a respective one of said latch support notches.

24. The subassembly of claim 22 including a pair of said latch release grip ears, a respective one of said pair protruding beyond each of said side walls of said handle and being located adjacent the respective latch support notch thereof.

25. The subassembly of claim 22 wherein said latch release grip ear extends along an outer face of a respective one of said side walls and thereby covers said latch support notch therein.

26. The subassembly of claim 21 wherein said latch release grip ear extends as a gusset between said locking bar and an arm of said latch release lever.
